(19) United States
(12) Patent Application Publication
(10) Pub. No.: US 2003/0109291 A1
(43) Pub. Date: Jun. 12, 2003

(54) Partitioning digital circuitry

(76) Inventor: Barak Ilan, Kfar Saba (IL)

Correspondence Address: Eitan, Pearl, Latzer & Cohen-Zedek, LLP, 10 Rockefeller Plaza, Suite 1001, New York, NY, 10020, US

(21) Appl. No.: 10/012,360

(22) Filed: Dec. 12, 2001

(51) Int. Cl. H04B 1/38

(52) U.S. Cl. 455/572; 455/550

(57) ABSTRACT

A method including partitioning digital circuitry components, which have at least one digital core voltage Vdd and which receive at least one supply voltage Vcc, into a plurality of N series connected digital blocks, wherein N is an integer ratio of Vcc to Vdd, and apportioning the at least one supply voltage Vcc to the digital blocks in accordance with the ratio N.

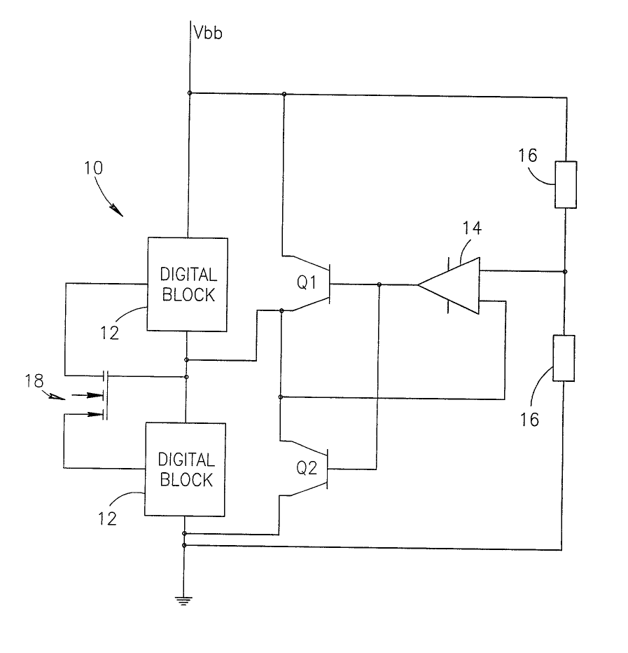

### BACKGROUND OF THE INVENTION

Baseband components used in digital cellular communication may require a low supply voltage, such as 0.5 V and less. This is problematic in mobile communication handset designs, because the battery source may be in the range of 2.5-3.6 V (in lithium-ion or lithium polymer batteries), which results in an inefficient use of energy. Although nickel-cadmium cells may have a lower voltage range, such as in the vicinity of 1.2 V, nevertheless they may not be preferred because power amplifiers used in digital cellular communication circuitry generally use 3.6 V.

One solution known in the art for adapting the battery voltage to the lower voltage required by the digital circuits is the use of a series regulator. However, this solution has a theoretical upper limit of efficiency of Vdd/Vcc, wherein Vcc is the battery voltage and Vdd is the digital chip core voltage. For example, for a typical battery voltage of 3.6 V and a chip core voltage of 1.5 V, the efficiency is theoretically limited to 1.5/3.6≅40%.

Another solution is the use of a switching regulator, wherein a power switch and a magnetic element, such as a ferrite inductor, are used to convert Vcc into Vdd. This solution has a peak efficiency of about 85%. However, there are several problems associated with using a switching regulator. First, the high efficiency of the switching regulator is achieved only at high current consumption, which in mobile communication handsets corresponds to a traffic (talking) mode of operation. However, at lower consumption levels, corresponding to standby or waiting modes of operation, the efficiency of the switching regulator is drastically reduced. Since the majority of the energy in standby or waiting modes is consumed by the digital baseband components, the loss of efficiency is significant. Second, there is radio frequency interference (RFI) from the switching regulator to the receiver antenna of the mobile handset. This RFI may be difficult to isolate from the antenna. Third, the structure of the switching regulator cannot readily be integrated into a digital chip.

### BRIEF DESCRIPTION OF THE DRAWINGS

The present invention will be understood and appreciated more fully from the following detailed description taken in conjunction with the appended drawing, which is a block diagram of a method and apparatus for digital cellular communication, in accordance with an embodiment of the invention.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Reference is now made to the single drawing, which illustrates a method and apparatus useful for digital circuitry, such as but not limited to, a cellular communication system adapted to receive signals from digital circuitry components, in accordance with an embodiment of the invention.

The apparatus may comprise a plurality of baseband digital cellular communication circuitry components 10, such as but not limited to, digital signal processor (DSP) chips or reduced instruction set computing (RISC) microprocessor chips. The circuitry components 10 may have at least one digital core voltage Vdd and receive at least one supply voltage Vcc. In accordance with an embodiment of the invention, the circuitry components 10 may be partitioned into a plurality of N connected digital blocks 12, wherein N is an integer ratio of Vcc to Vdd. The digital blocks 12 may be connected in series. If some blocks are connected in parallel, then the parallel-connected blocks may comprise one “conglomerate” digital block 12 which may be connected in series to other digital blocks 12.

The supply voltage Vcc may be apportioned to digital blocks 12 in accordance with the ratio N. If the N digital blocks 12 drain equal current, then the voltage division between the blocks may be perfect with an efficiency of 100%. However, if there is some current mismatch between the digital blocks 12, i.e., one of the digital blocks 12 may have a current in excess of a current of another block, then the excess current may be drained to maintain a generally equal voltage split between the blocks.

One way of maintaining a generally equal voltage split between the blocks is shown in the drawing. A feedback circuit may be employed, which may comprise without limitation an error amplifier 14, a voltage divider 16 and pass elements (e.g., transistors) Q1 and Q2. If the error amplifier 14 senses a voltage error between the actual voltage level at the interconnect point of the pair of blocks 12, and a predefined voltage level at the voltage divider 16 output, pass elements Q1 or Q2 may drain the excess current to maintain an equal voltage split between the pair of blocks 12. It is appreciated that error amplifier 14 and pass elements Q1 and Q2 are just examples of circuit elements, and other circuit elements may be used to drain excess current from one block to another, and to maintain a generally equal voltage split between at least two of the blocks.

A voltage output of one of the blocks 12 may be used as an input to another of the blocks 12, as seen in the drawing. However, the voltage output level of one block may be at an insufficient level to serve as the input to the next block. Accordingly, in accordance with an embodiment of the invention, a voltage output level of one of the blocks may be converted to a different voltage level that may be the input voltage to another block. For example, a level converter 18, or any other equivalent circuit element, may be connected to the output of one of the blocks and the input of another of the blocks. The level converter 18 may convert the voltage output level of one of the blocks to the desired input level for another block.

The scope of the invention is defined by the claims that follow:

What is claimed is:

1. A method comprising:
partitioning digital circuitry components, which have at least one digital core voltage Vdd and which receive at least one supply voltage Vcc, into a plurality of N series connected digital blocks, wherein N is an integer ratio of Vcc to Vdd, and apportioning said at least one supply voltage Vcc to said digital blocks in accordance with the ratio N.

2. The method according to claim 1, wherein if one of said digital blocks has a current in excess of a current of another of said blocks, the method further comprises draining the excess current from said one of said blocks to said another of said blocks.

3. The method according to claim 1 and further comprising maintaining a generally equal voltage split between at least two of said blocks.

4. The method according to claim 1 and further comprising converting a voltage output level of one of said blocks to another voltage level which is an input voltage to another of said blocks.

5. An apparatus comprising:
digital circuitry components, which have at least one digital core voltage Vdd and which receive at least one supply voltage Vcc, partitioned into a plurality of N connected digital blocks, wherein N is an integer ratio of Vcc to Vdd.

6. Apparatus according to claim 5, wherein said blocks are serially connected together.

7. Apparatus according to claim 5 and further comprising a circuit element adapted to drain excess current from one of said blocks to another of said blocks.

8. Apparatus according to claim 5 and further comprising a circuit element adapted to maintain a generally equal voltage split between at least two of said blocks.

9. Apparatus according to claim 5 and further comprising a circuit element adapted to convert a voltage output level of one of said blocks to another voltage level which is an input voltage to another of said blocks.

10. Apparatus according to claim 5 wherein said digital circuitry components comprise at least one of digital signal processor (DSP) chips and reduced instruction set computing (RISC) microprocessor chips.

11. A system comprising:
digital circuitry components, which have at least one digital core voltage Vdd and which receive at least one supply voltage Vcc, partitioned into a plurality of N connected digital blocks, wherein N is an integer ratio of Vcc to Vdd; and
a cellular communication system adapted to receive signals from said digital circuitry components.

12. The system according to claim 11, wherein said blocks are serially connected to each other.

13. The system according to claim 11 and further comprising a circuit element adapted to drain excess current from one of said blocks to another of said blocks.

14. The system according to claim 11 and further comprising a circuit element adapted to maintain a generally equal voltage split between at least two of said blocks.

15. The system according to claim 11 and further comprising a circuit element adapted to convert a voltage output level of one of said blocks to another voltage level which is an input voltage to another of said blocks.

16. The system according to claim 11 wherein said circuitry components comprise at least one of digital signal processor (DSP) chips and reduced instruction set computing (RISC) microprocessor chips.
